(19) United States
(12) Patent Application Publication
(10) Pub. No.: US 2006/0041388 A1
(43) Pub. Date: Feb. 23, 2006

(54) Oligosaccharides fragmentation pattern analysis system and oligosaccharides fragmentation pattern analysis method

(76) Inventors: Kazuhiko Fukui, Tokyo (JP); Katsutoshi Takahashi, Tokyo (JP); Yuri Mukai, Tokyo (JP); Akihiko Kameyama, Tsukuba-shi (JP); Hisashi Narimatsu, Tsukuba-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/207,005

(22) Filed: Aug. 19, 2005

(30) Foreign Application Priority Data
Aug. 20, 2004 (JP) 2004-240845

(51) Int. Cl. G06F 19/00

(52) U.S. Cl. 702/19; 702/20

(57) ABSTRACT

Oligosaccharides fragmentation pattern analysis system 10 includes: a geometry optimization part for calculating an optimized structure of an ionized oligosaccharide; a binding parameter extraction part for extracting multiple kinds of binding parameters which relate to bond strengths for respective multiple candidate bonds to be the candidate of the cleavage site within the oligosaccharide from the calculation results by the geometry optimization part; a parameter conversion part for converting respective multiple kinds of binding parameters extracted at the binding parameter extraction part, into binding scores; a weight information storage part for storing the weight information representing contribution to respective bond strengths of multiple kinds of binding scores; and a total score calculating part for determining total score of multiple kinds of binding scores in each candidate bond such that the multiple kinds of binding parameters are weighed according to the weight information.

### BACKGROUND OF THE INVENTION

1. Field of the Invention

The present invention relates to a system for determining fragmentation pattern of ionized oligosaccharides by calculation.

2. Background

In life science fields, proteomics has been known as a coming research theme in connection with entire base sequence analysis of a gene. Proteomics aims elucidation of roles of a protein in a living body through analyzing protein functions. In recent years, along with the development of this proteomics analysis, presence of close relationship between various diseases and posttranslational modification of proteins has been suggested. In particular, studies on oligosaccharides which may be the basis of posttranslational modification of proteins have been regarded as an important factor for elucidating a biological function in addition to genomics and proteomics. Studies on structural analyses of glycoproteins referred to as glycoproteomics have been initiated in an attempt to elucidate the function of oligosaccharides carried by glycoproteins.

### SUMMARY OF THE INVENTION

Glycoproteins modified with oligosaccharides account for about 50% of proteins in a living body. Similar to proteomics, mass spectrometry system (MS) capable of rapidly analyzing in a slight amount has been an indispensable tool of analysis also in the research field of glycoproteomics. Enormous time has been required for identification of complex mass spectra of oligosaccharides obtained by a mass spectrometer (the n-th power of MS). Grounds for making identification in the MS structural analysis difficult include: (1) presence of a linkage such as glycosidic linkage, or of an anomer isomer, (2) branched structure of oligosaccharides, (3) discrimination of the configuration (Glc, Gal, Man) and the like. Under the current situation, evolution of the mass spectrometry system has not been readily lead to improvement of processing speed of the analysis.

Because oligosaccharides have structural diversity, many parts thereof have not been elucidated yet. For example, only six kinds of oligopeptides can be formed from three amino acids via an amide bond, however, in cases of oligosaccharides to the contrary, oligosaccharides of 1000 or more kinds of structures can be formed from three monosaccharides. In cases of the oligosaccharides, a polymer is formed through glycosidic linking of monosaccharides, however, combination of order and position of linkage of each monosaccharide, as well as the linkage being either α-bond or β-bond, or the like can create many kinds of structures.

Improvement of structural analyses of oligosaccharides requires both development of the experiment system and information technologies. With respect to the experiment, striking evolution has been made owing to development of ionidization method and fragmentation method. However, theoretical researches on dissociation pattern and high speed identification processing of fragments detected from the resulting spectra have been scarcely carried out.

Identification of oligosaccharides will be further explained. When energy is applied on an oligosaccharide, a part of linkages between the monosaccharide and monosaccharide included in the oligosaccharide is cleaved, and thus, one oligosaccharide is fragmented to give multiple oligosaccharides. In an oligosaccharide, information suggesting parts to be cleaved is referred to as a fragmentation pattern. The fragmentation pattern varies depending on the structure of the oligosaccharide. Therefore, for the purpose of identifying a structure of an unknown oligosaccharide, it is useful to construct the database in which fragmentation patterns of oligosaccharides are accumulated. Structure of an unknown oligosaccharide can be identified by determining fragmentation pattern of the unknown oligosaccharide by mass spectrometry, and searching for oligosaccharide correlating to the fragmentation pattern from the database.

For the present, as a method of determination of fragmentation pattern of oligosaccharides, experiments by means of mass spectrometry have been known. First, a cation for carrying out mass spectrometry is added to a subject oligosaccharide to be analyzed. Next, energy is applied to the ionized oligosaccharide to allow for fragmentation of the oligosaccharide, followed by carrying out mass spectrometry to determine the fragmentation pattern of the oligosaccharide.

However, since oligosaccharides have structural diversity as described above, kinds of the oligosaccharides are enormous. Enormous efforts and time are required in order to determine the fragmentation pattern of all oligosaccharides by mass spectrometry. Therefore, rapid analyses of oligosaccharides fragmentation pattern have been desired.

Thus, taking into account of the aforementioned background, an object of the invention it to provide an oligosaccharides fragmentation pattern analysis system for determining fragmentation pattern of ionized oligosaccharides by calculation based on molecular structure of the oligosaccharides.

Oligosaccharides fragmentation pattern analysis system according to this invention is an oligosaccharides fragmentation pattern analysis system for analyzing a fragmentation pattern of an oligosaccharide ionized to obtain mass spectra for oligosaccharides, by calculation based on the molecular structure, the system comprising: a geometry optimization part for calculating the optimized structure of the oligosaccharide ionized by addition of a cation; a binding parameter extraction part for extracting respective multiple kinds of binding parameters which relate to bond strengths for multiple candidate bonds, which are to be the candidate of cleavage site within the oligosaccharide, on the basis of results of calculation by means of the geometry optimization part; a parameter conversion part for converting respective multiple kinds of binding parameters extracted at the binding parameter extraction part into binding scores such that the binding score correlates to magnitude relationship of the same kind of binding parameter in the multiple candidate bonds; a weight information storage part for storing weight information which represents contribution to respective bond strengths, of multiple kinds of the binding scores correlating to the multiple kinds of binding parameters; and a total score calculating part for reading the weight information from the weight information storage part and for determining total score of the multiple kinds of binding scores in each candidate bond as the information representing the fragmentation pattern of the oligosaccharide such that the multiple kinds of binding parameters are weighed according to the read weight information.

The oligosaccharides fragmentation pattern analysis system described above may also include a cleavage site deciding part for deciding a candidate bond that is most cleavable, based on the total score calculated at the total score calculating part.

In the oligosaccharides fragmentation pattern analysis system described above, the binding parameter extraction part may extract, as the binding parameter, multiple parameters among bond length and bond order of the candidate bond, distance between the candidate bond and the cation, number of interacted oxygen atoms with the metal cation among oxygen atoms included in the monosaccharide linked by the candidate bond, magnitude of alteration of charge of oxygen atoms and carbon atoms of the candidate bond, accompanied by addition of the cation, and resonant term indicating the electronic state of the oxygen atoms and carbon atoms of the candidate bond.

In the oligosaccharides fragmentation pattern analysis system described above, the binding parameter extraction part may change the parameter extracted as the binding parameter depending on kinds of the monosaccharides included in the subject oligosaccharide to be analyzed.

In the analytical system of the oligosaccharides fragmentation pattern described above, the binding parameter extraction part may extract, as the binding parameter, the bond length and bond order of the candidate bond, the distance between the candidate bond and the cation, and the number of interacted oxygen atoms with metal cation among oxygen atoms included in the monosaccharide linked by the candidate bond.

In the oligosaccharides fragmentation pattern analysis system described above, the binding parameter extraction part may extract, as the binding parameter, the bond order of the candidate bond, the distance between the candidate bond and the cation, the number of interacted oxygen atoms with metal cation among oxygen atoms included in the monosaccharide linked by the candidate bond, and the magnitude of alteration of charge of oxygen atoms and carbon atoms of the candidate bond, accompanied by addition of the cation, when neuraminic acid is included in the subject oligosaccharide to be analyzed.

In the oligosaccharides fragmentation pattern analysis system described above, the binding parameter extraction part may extract, as the binding parameter, the bond length and bond order of the candidate bond, the distance between the candidate bond and the cation, the number of interacted oxygen atoms with metal cation among oxygen atoms included in the monosaccharide linked by the candidate bond, and the magnitude of alteration of charge of oxygen atoms and carbon atoms of the candidate bond, accompanied by addition of the cation, when the subject oligosaccharide to be analyzed includes fucose and does not include neuraminic acid.

In the oligosaccharides fragmentation pattern analysis system described above, the weight information storage part may store multiple weight information in association with kind of the monosaccharide included in the subject oligosaccharide to be analyzed; and the total score calculating part may read the weight information, which correlates to the kind of the monosaccharide included in the subject oligosaccharide to be analyzed, from the weight information storage part, and may calculate the total score using thus read weight information.

In the oligosaccharides fragmentation pattern analysis system described above, for the weight information applied in cases where neuraminic acid is included in the subject oligosaccharide to be analyzed among the multiple weight information stored in the weight information storage part, contribution to the bond strength of the binding score correlating to the binding parameter of the bond order of the candidate bond is set to be greater, while contribution to the bond strength of the binding score correlating to the binding parameter of the distance between the candidate bond and the cation and of the number of interacted oxygen atoms with metal cation among oxygen atoms included in the monosaccharide linked by the candidate bond is set to be smaller, in comparison with cases where neuraminic acid is not included in the subject.

In the oligosaccharides fragmentation pattern analysis system described above, the parameter conversion part may assign the order of all the candidate bonds within the oligosaccharide based on the same type of the binding parameter, and may convert into the binding score of the candidate bond according to the order.

The oligosaccharides fragmentation pattern analysis system described above may comprise a chemical formula input part which accepts input of the chemical formula of the subject oligosaccharide to be analyzed, an addition candidate position calculating part for determining, as an addition candidate position, a position to which a cation can be added on the basis of the optimized structure of the oligosaccharide, and a selection accepting part for displaying the addition candidate position determined by the addition candidate position calculating part, and for accepting selection of the position to which the cation is added from the displayed addition candidate positions, wherein the aforementioned geometry optimization part may calculate the optimized structure of the oligosaccharide having the cation added to the position accepted by the selection accepting part.

The oligosaccharides fragmentation pattern analysis system described above may comprise a chemical formula input part for accepting input of the chemical formula of the subject oligosaccharide to be analyzed, and an addition candidate position calculating part for determining the position to which the cation can be added as the addition candidate position on the basis of the optimized structure of the oligosaccharide, wherein the optimized structure of the oligosaccharide when the cation is added to respective addition candidate positions is calculated by the geometry optimization part to determine stability of each oligosaccharide from the results of the calculation, and a cation addition position deciding part for deciding a position to which the cation is added, on the basis of the stability of each oligosaccharide may be provided.

Oligosaccharides fragmentation pattern analysis method according to this invention is an oligosaccharides fragmentation pattern analysis method for analyzing a fragmentation pattern of an oligosaccharide ionized to obtain mass spectra for oligosaccharides, by calculation based on the molecular structure, the method comprising steps of: geometry optimization for calculating the optimized structure of the oligosaccharide ionized by addition of a cation; binding parameter extraction for extracting multiple kinds of binding parameters which relate to bond strengths for multiple candidate bonds, respectively, which are to be the candidate of cleavage site within the oligosaccharide, on the basis of results of calculation in the geometry optimization step; parameter conversion for converting respective multiple kinds of binding parameters extracted at the binding parameter extraction step into binding scores such that the binding score correlates to magnitude relationship of the same kind of binding parameter in the multiple candidate bonds; weight information reading for reading the weight information which represents contribution to respective bond strengths of multiple kinds of the binding scores correlating to the multiple kinds of binding parameters, from the weight information storing part; and total score calculation for determining total score of the multiple kinds of binding scores in each candidate bond as the information representing the fragmentation pattern of the oligosaccharide such that the multiple kinds of binding parameters are weighed according to the weight information read in the weight information reading step.

Program of this invention is a program for analyzing a fragmentation pattern of an oligosaccharide ionized to obtain mass spectra for oligosaccharides, by calculation based on the molecular structure, the program allowing a computer to execute steps of: geometry optimization for calculating the optimized structure of the oligosaccharide ionized by addition of a cation; binding parameter extraction for extracting multiple kinds of binding parameters which relate to bond strengths for multiple candidate bonds, respectively, which are to be the candidate of cleavage site within the oligosaccharide, on the basis of results of calculation in the geometry optimization step; parameter conversion for converting respective multiple kinds of binding parameters extracted at the binding parameter extraction step into binding scores such that the binding score correlates to magnitude relationship of the same kind of binding parameter in the multiple candidate bonds; weight information reading for reading the weight information which represents contribution to respective bond strengths of multiple kinds of the binding scores correlating to the multiple kinds of binding parameters, from the weight information storing part; and total score calculation for determining total score of the multiple kinds of binding scores in each candidate bond as the information representing the fragmentation pattern of the oligosaccharide such that the multiple kinds of binding parameters are weighed according to the weight information read in the weight information reading step.

As described hereafter, other aspects of the invention exist. Thus, this summary of the invention is intended to provide a few aspects of the invention and is not intended to limit the scope of the invention described and claimed herein.

### BRIEF DESCRIPTION OF THE DRAWINGS

The accompanying drawings are incorporated in and constitute a part of this specification. The drawings exemplify certain aspects of the invention and, together with the description, serve to explain some principles of the invention.

FIG. 1 is a drawing illustrating a construction of an oligosaccharides fragmentation pattern analysis system.

FIG. 2 is a drawing illustrating an oligosaccharide represented by GalNAcβ1-3(Fucα1-2)Gal.

FIG. 3 is a drawing illustrating a function block of the oligosaccharides fragmentation pattern analysis system.

FIG. 4 is a drawing illustrating examples of binding parameters of each candidate bond.

FIG. 5 is a drawing illustrating a contact map.

FIG. 6 is a drawing illustrating a charge map.

FIG. 7A is a drawing illustrating scores of each binding parameter.

FIG. 7B is a drawing illustrating total scores.

FIG. 8 is a drawing illustrating the data stored in a weight information storage part.

FIG. 9 is a drawing illustrating operations of the oligosaccharides fragmentation pattern analysis system.

FIG. 10 is a drawing illustrating operations of selecting the weight information read from the weight information storage part.

FIG. 11 is a drawing illustrating experimental results obtained by determining a fragmentation pattern of an oligosaccharide by mass spectrometry.

FIG. 12 is a drawing illustrating an oligosaccharide represented by Neu5Acα2-3Galβ1-4Gal.

FIG. 13A is a drawing illustrating scores of each binding parameter.

FIG. 13B is a drawing illustrating total scores.

FIG. 14 is a drawing illustrating experimental results obtained by determining a fragmentation pattern of an oligosaccharide by mass spectrometry.

FIG. 15 is a drawing illustrating an oligosaccharide represented by Galα1-3Galβ1-Gal.

FIG. 16A is a drawing illustrating scores of each binding parameter.

FIG. 16B is a drawing illustrating total scores.

FIG. 17 is a drawing illustrating experimental results obtained by determining a fragmentation pattern of an oligosaccharide by mass spectrometry.

### DETAILED DESCRIPTION

Oligosaccharides fragmentation pattern analysis system according to this embodiment is an oligosaccharides fragmentation pattern analysis system for analyzing a fragmentation pattern of an oligosaccharide ionized to obtain mass spectra for oligosaccharides, by calculation based on the molecular structure, the system comprising: a geometry optimization part for calculating the optimized structure of the oligosaccharide ionized by addition of a cation; a binding parameter extraction part for extracting respective multiple kinds of binding parameters which relate to bond strengths for multiple candidate bonds, which are to be the candidate of cleavage site within the oligosaccharide, on the basis of results of calculation by means of the geometry optimization part; a parameter conversion part for converting respective multiple kinds of binding parameters extracted at the binding parameter extraction part into binding scores such that the binding score correlates to magnitude relationship of the same kind of binding parameter in the multiple candidate bonds; a weight information storage part for storing weight information which represents contribution to respective bond strengths, of multiple kinds of the binding scores correlating to the multiple kinds of binding parameters; and a total score calculating part for reading the weight information from the weight information storage part and for determining total score of the multiple kinds of binding scores in each candidate bond as the information representing the fragmentation pattern of the oligosaccharide such that the multiple kinds of binding parameters are weighed according to the read weight information.

According to this embodiment, fragmentation pattern can be analyzed by calculation, from the results of geometry optimization of an oligosaccharide to which a cation was added, through extracting a binding parameter of each candidate bond, and determining total score representing the fragmentation pattern information based on the binding parameter. Conversion of the binding parameter of the candidate bond into the binding score enables multiple binding parameters of different kinds to be treated integrally. Determination of the total score using the weight information representing contribution to the bond strength enables the total score to be adequately determined from the multiple kinds of binding parameters.

The oligosaccharides fragmentation pattern analysis system described above may also include a cleavage site deciding part for deciding a candidate bond that is most cleavable, based on the total score calculated at the total score calculating part.

Determination of the candidate bond, which is most cleavable, with the cleavage site deciding part enables fragmentation pattern of oligosaccharides to be readily comprehended.

In the oligosaccharides fragmentation pattern analysis system described above, the binding parameter extraction part may extract, as the binding parameter, multiple parameters among bond length and bond order of the candidate bond, distance between the candidate bond and the cation, number of interacted oxygen atoms with the metal cation among oxygen atoms included in the monosaccharide linked by the candidate bond, magnitude of alteration of charge of oxygen atoms and carbon atoms of the candidate bond, accompanied by addition of the cation, and resonant term indicating the electronic state of the oxygen atoms and carbon atoms of the candidate bond.

In the oligosaccharides fragmentation pattern analysis system described above, the binding parameter extraction part may change the parameter extracted as the binding parameter depending on kinds of the monosaccharides included in the subject oligosaccharide to be analyzed.

According to extraction of appropriate binding parameter depending on kinds of the monosaccharides included in the oligosaccharide enables the fragmentation pattern to be determined with favorable accuracy.

In the analytical system of the oligosaccharides fragmentation pattern described above, the binding parameter extraction part may extract, as the binding parameter, the bond length and bond order of the candidate bond, the distance between the candidate bond and the cation, and the number of interacted oxygen atoms with metal cation among oxygen atoms included in the monosaccharide linked by the candidate bond.

In the oligosaccharides fragmentation pattern analysis system described above, the binding parameter extraction part may extract, as the binding parameter, the bond order of the candidate bond, the distance between the candidate bond and the cation, the number of interacted oxygen atoms with metal cation among oxygen atoms included in the monosaccharide linked by the candidate bond, and the magnitude of alteration of charge of oxygen atoms and carbon atoms of the candidate bond, accompanied by addition of the cation, when neuraminic acid is included in the subject oligosaccharide to be analyzed.

When neuraminic acid is included in the subject oligosaccharide to be analyzed, the fragmentation pattern can be determined with favorable accuracy by using the multiple parameters as the binding parameter.

In the oligosaccharides fragmentation pattern analysis system described above, the binding parameter extraction part may extract, as the binding parameter, the bond length and bond order of the candidate bond, the distance between the candidate bond and the cation, the number of interacted oxygen atoms with metal cation among oxygen atoms included in the monosaccharide linked by the candidate bond, and the magnitude of alteration of charge of oxygen atoms and carbon atoms of the candidate bond, accompanied by addition of the cation, when the subject oligosaccharide to be analyzed includes fucose and does not include neuraminic acid.

When fucose is included and neuraminic acid is not included in a subject oligosaccharide to be analyzed, the fragmentation pattern can be determined with favorable accuracy by using the multiple parameters as the binding parameter.

In the oligosaccharides fragmentation pattern analysis system described above, the weight information storage part may store multiple weight information in association with kind of the monosaccharide included in the subject oligosaccharide to be analyzed; and the total score calculating part may read the weight information, which correlates to the kind of the monosaccharide included in the subject oligosaccharide to be analyzed, from the weight information storage part, and may calculate the total score using thus read weight information.

The fragmentation pattern can be determined with favorable accuracy through: storing multiple weight information in the weight information storage part, depending on the kind of the monosaccharide included in the subject oligosaccharide to be analyzed; and reading and using appropriate weight information depending on the kind of the monosaccharide included in the oligosaccharide upon calculation of the total score, in this manner.

In the oligosaccharides fragmentation pattern analysis system described above, for the weight information applied in cases where neuraminic acid is included in the subject oligosaccharide to be analyzed among the multiple weight information stored in the weight information storage part, contribution to the bond strength of the binding score correlating to the binding parameter of the bond order of the candidate bond is set to be greater, while contribution to the bond strength of the binding score correlating to the binding parameter of the distance between the candidate bond and the cation and of the number of interacted oxygen atoms with metal cation among oxygen atoms included in the monosaccharide linked by the candidate bond is set to be smaller, in comparison with cases where neuraminic acid is not included in the subject.

When neuraminic acid is included in the subject oligosaccharide to be analyzed, the fragmentation pattern can be determined with favorable accuracy by increasing the contribution of the bond order, while decreasing the contribution of the distance between the cation and the candidate bond as well as number of the interacted oxygen atoms.

In the oligosaccharides fragmentation pattern analysis system described above, the parameter conversion part may assign the order of all the candidate bonds within the oligosaccharide based on the same type of the binding parameter, and may convert into the binding score of the candidate bond according to the order.

This construction enables the binding parameter to be converted into the binding score according to the magnitude relationship of the same type of multiple binding parameters.

The oligosaccharides fragmentation pattern analysis system described above may comprise a chemical formula input part which accepts input of the chemical formula of the subject oligosaccharide to be analyzed, an addition candidate position calculating part for determining, as an addition candidate position, a position to which a cation can be added on the basis of the optimized structure of the oligosaccharide, and a selection accepting part for displaying the addition candidate position determined by the addition candidate position calculating part, and for accepting selection of the position to which the cation is added from the displayed addition candidate positions, wherein the aforementioned geometry optimization part may calculate the optimized structure of the oligosaccharide having the cation added to the position accepted by the selection accepting part.

By thus designing the construction in which selection of position to which the cation is added is accepted by the selection accepting part, the fragmentation pattern can be analyzed through altering the position to which the cation is added.

The oligosaccharides fragmentation pattern analysis system described above may comprise a chemical formula input part for accepting input of the chemical formula of the subject oligosaccharide to be analyzed, and an addition candidate position calculating part for determining the position to which the cation can be added as the addition candidate position on the basis of the optimized structure of the oligosaccharide, wherein the optimized structure of the oligosaccharide when the cation is added to respective addition candidate positions is calculated by the geometry optimization part to determine stability of each oligosaccharide from the results of the calculation, and a cation addition position deciding part for deciding a position to which the cation is added, on the basis of the stability of each oligosaccharide may be provided.

By deciding the position to which the cation is added based on the stability of the oligosaccharide when the cation is added to respective addition candidate positions, fragmentation pattern of the oligosaccharide can be analyzed when the cation is added at a position that is the most stable.

Oligosaccharides fragmentation pattern analysis method according to this embodiment is an oligosaccharides fragmentation pattern analysis method for analyzing a fragmentation pattern of an oligosaccharide ionized to obtain mass spectra for oligosaccharides, by calculation based on the molecular structure, the method comprising steps of: geometry optimization for calculating the optimized structure of the oligosaccharide ionized by addition of a cation; binding parameter extraction for extracting multiple kinds of binding parameters which relate to bond strengths for multiple candidate bonds, respectively, which are to be the candidate of cleavage site within the oligosaccharide, on the basis of results of calculation in the geometry optimization step; parameter conversion for converting respective multiple kinds of binding parameters extracted at the binding parameter extraction step into binding scores such that the binding score correlates to magnitude relationship of the same kind of binding parameter in the multiple candidate bonds; weight information reading for reading the weight information which represents contribution to respective bond strengths of multiple kinds of the binding scores correlating to the multiple kinds of binding parameters, from the weight information storing part; and total score calculation for determining total score of the multiple kinds of binding scores in each candidate bond as the information representing the fragmentation pattern of the oligosaccharide such that the multiple kinds of binding parameters are weighed according to the weight information read in the weight information reading step.

Similarly to the oligosaccharides fragmentation pattern analysis system of this embodiment, the fragmentation pattern can be analyzed by calculation through determining total score which represents the information of the fragmentation pattern based on binding parameters of respective candidate bonds. Also, each type of construction of the oligosaccharides fragmentation pattern analysis system of this embodiment can be applied to the oligosaccharides fragmentation pattern analysis method of this embodiment.

Program of this embodiment is a program for analyzing a fragmentation pattern of an oligosaccharide ionized to obtain mass spectra for oligosaccharides, by calculation based on the molecular structure, the program allowing a computer to execute steps of: geometry optimization for calculating the optimized structure of the oligosaccharide ionized by addition of a cation; binding parameter extraction for extracting multiple kinds of binding parameters which relate to bond strengths for multiple candidate bonds, respectively, which are to be the candidate of cleavage site within the oligosaccharide, on the basis of results of calculation in the geometry optimization step; parameter conversion for converting respective multiple kinds of binding parameters extracted at the binding parameter extraction step into binding scores such that the binding score correlates to magnitude relationship of the same kind of binding parameter in the multiple candidate bonds; weight information reading for reading the weight information which represents contribution to respective bond strengths of multiple kinds of the binding scores correlating to the multiple kinds of binding parameters, from the weight information storing part; and total score calculation for determining total score of the multiple kinds of binding scores in each candidate bond as the information representing the fragmentation pattern of the oligosaccharide such that the multiple kinds of binding parameters are weighed according to the weight information read in the weight information reading step.

Similarly to the oligosaccharides fragmentation pattern analysis system of this embodiment, the fragmentation pattern can be analyzed by calculation through determining total score which represents the information of the fragmentation pattern based on binding parameters of respective candidate bonds. Also, each type of construction of the oligosaccharides fragmentation pattern analysis system of this embodiment can be applied to the program of this embodiment.

The embodiments have an excellent effect which enables analysis of the fragmentation pattern through calculation through extracting a binding parameter of respective candidate bonds from the results of geometry optimization of the oligosaccharide to which a cation is added, and determining total score which represents the information of the fragmentation pattern based on the binding parameter.

Hereinafter, the oligosaccharides fragmentation pattern analysis system according to an embodiment of the invention will be explained with reference to drawings.

The oligosaccharides fragmentation pattern analysis system of the embodiment is a system for analyzing a fragmentation pattern of oligosaccharides ionized by addition of a cation. The oligosaccharides fragmentation pattern analysis system enables determination of fragmentation pattern of oligosaccharides by way of calculation. Accordingly, fragmentation pattern of the oligosaccharides can be rapidly calculated without carrying out mass spectrometry. In order to determine a fragmentation pattern of the oligosaccharide in the oligosaccharides fragmentation pattern analysis system of this embodiment under the identical condition to that when mass spectrometry is carried out, fragmentation pattern of an oligosaccharide which was ionized by adding a Na ion is analyzed.

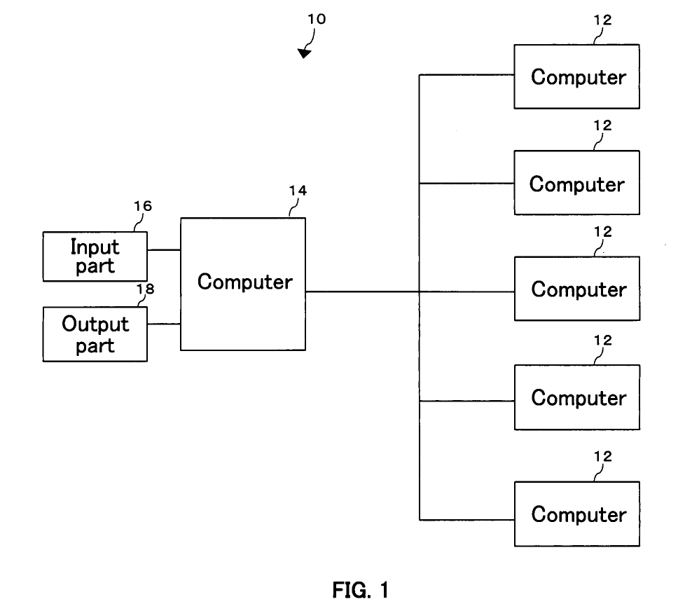

FIG. 1 is a drawing illustrating a construction of an oligosaccharides fragmentation pattern analysis system 10 according to first embodiment. The oligosaccharides fragmentation pattern analysis system 10 is constructed by connecting multiple computers 12 for carrying out geometry optimization of an oligosaccharide to a computer 14 for determining the information indicating fragmentation pattern based on the calculation results of the geometry optimization. The computer 14 has an input part 16 and an output part 18. The hardware constructing the input part 16 may be, for example, a keyboard, a mouse, a data reading system for reading data of the file or the like. The hardware constructing the output part 18 may be, for example, a display, or a data storing system for storing data in a file. The oligosaccharides fragmentation pattern analysis system 10 accepts data of the subject oligosaccharide to be analyzed from the input part 16, and outputs the analysis results from the output part 18. According to this embodiment, construction of the oligosaccharides fragmentation pattern analysis system 10 from multiple computers 12 and 14 enables the geometry optimization to be subjected to a distributed processing, thereby alleviating load on each computer 12 and 14 to make calculation processing execute faster.

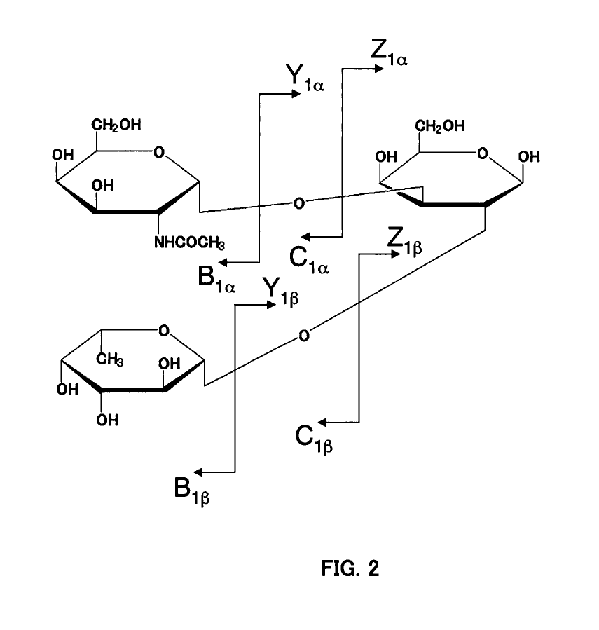

FIG. 2 is a drawing illustrating an example of the subject oligosaccharide to be analyzed. Before detailed explanation of the analytical system 10 of the fragmentation pattern, fragmentation of an oligosaccharide will be explained with reference to FIG. 2. The oligosaccharide shown in FIG. 2 is an oligosaccharide represented by the chemical formula of GalNAcβ1-3(Fucα1-2)Gal, and includes three monosaccharides of N-acetylgalactosamine, galactose and fucose. N-acetylgalactosamine and galactose, and fucose and galactose are respectively bound by a glycosidic linkage. The glycosidic linkage is a form to link two monosaccharides via an oxygen atom. This glycosidic linkage becomes a candidate of the cleavage site of the oligosaccharide cleaved when energy is applied to the oligosaccharide. More particularly, the glycosidic linkage is formed by binding of a carbon atom included in one monosaccharide to an oxygen atom, and additional binding of the oxygen atom to a carbon atom included in another monosaccharide. Thus, two monosaccharides are linked via the oxygen atom. That is, a glycosidic linkage has binding parts on both sides of interposing oxygen atom. Cleavage sites to be the candidate in one glycosidic linkage are two sites of a binding part between one monosaccharide and the oxygen atom, and a binding part between another monosaccharide and the oxygen atom. Herein, a binding part to be the candidate of the cleavage site is referred to as “candidate bond”. The oligosaccharide shown in FIG. 2 includes candidate bonds at 4 sites: B1α/Y1α, C1α/Z1α, B1β/Y1β and C1β/Z1β.

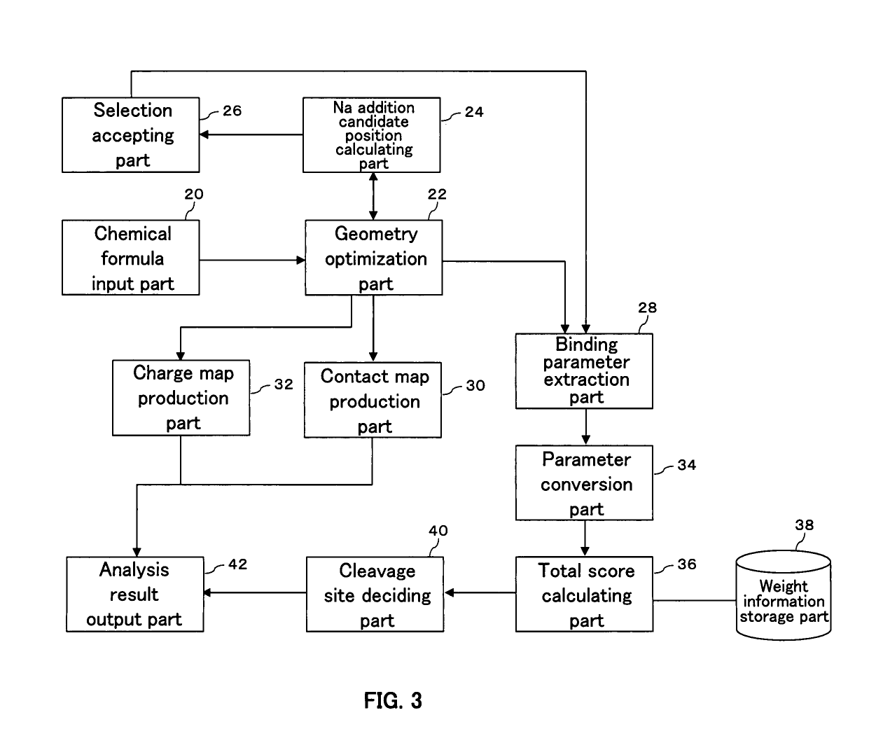

The oligosaccharides fragmentation pattern analysis system 10 of this embodiment will be explained. FIG. 3 is a drawing illustrating a function block diagram of the oligosaccharides fragmentation pattern analysis system 10 of this embodiment. Hereinafter, each function of the oligosaccharides fragmentation pattern analysis system 10 shown in FIG. 3 will be explained.

Chemical formula input part 20 has a function to accept input of the chemical formula of the subject oligosaccharide to be analyzed, and position to which the cation is added to the oligosaccharide, and the like. The chemical formula input part 20 gives the entered data of the chemical formula of the oligosaccharide to geometry optimization part 22.

Geometry optimization carried out by the geometry optimization part 22 is now explained. The geometry optimization is calculation for determining stable structure of a molecule, and the molecular orbital in such a structure. The geometry optimization can be carried out by executing a soft for molecular orbital calculations. The geometry optimization part 22 first evaluates an oligosaccharide with a time independent Molecular Mechanics method using empirical potential. Subsequently, the geometry optimization part 22 inquires validity of the energy and structure by semi-empirical molecular orbital calculations (PM3/PM5 method), and thereafter, glycosidic linkage as well as tertiary structure and energy are determined using 6-31G* as a basis function in a Hatree-Fock method as ab initio molecular orbital calculations. For the semi-empirical molecular orbital calculations, and ab initio molecular orbital calculations, GAUSSIAN (registered trade name) can be used. If necessary, a calculation level MP method or a density functional formalism B3LYP method may be used to take still greater basis function into consideration. According to this calculation, calculation level is elevated stepwise to perfect exhaustive calculation through narrowing down important structures while sifting. Also for molecular orbital calculations of glycopeptide, the stepwise calculation as described above can be executed taking into account of O-glycoside linked oligosaccharides or N-glycoside linked oligosaccharides. Because great load of computation processing is imposed by the geometry optimization, it is suitable to disperse the load by calculation with a PC cluster connected to multiple computers 12, as shown in FIG. 1.

The geometry optimization part 22 carries out geometry optimization using the data of the chemical formula of an oligosaccharide given from the chemical formula input part 20, and gives the calculation results to Na addition candidate position calculating part 24. The geometry optimization part 22 carries out the geometry optimization of the oligosaccharide to which a Na ion was added at respective addition candidate positions determined by the Na addition candidate position calculating part 24, and the calculation results are given to the Na addition candidate position calculating part 24.

The Na addition candidate position calculating part 24 determines multiple candidate positions to be the candidate of addition of Na ion from the results of the geometry optimization. The Na addition candidate position calculating part 24 gives the data of positions to be the candidate of the determined Na addition position to the geometry optimization part 22. The Na addition candidate position calculating part 24 assigns the order of facility in adding the Na ion to the multiple addition candidate positions, based on the results of geometry optimization of the oligosaccharide in adding the Na ion as determined at the geometry optimization part 22. The Na addition candidate position calculating part 24 gives the information of the addition candidate position of Na ion, and the information of the order thereof to selection accepting part 26.

The selection accepting part 26 presents the Na addition candidate positions determined at the Na addition candidate position calculating part 24 to the user, and accepts selection of the positions to which the Na ion is added among the presented Na addition candidate positions.

Binding parameter extraction part 28 receives from the geometry optimization part 22 the results of geometry optimization of the oligosaccharide in case where Na ion was added to the addition candidate position accepted at the selection accepting part 26, and extracts multiple kinds of binding parameters from the received calculation results. According to this embodiment, the binding parameter extraction part 28 extracts parameters of bond length, bond order, Na distance, number of interacted atoms, magnitude of alteration of charge, for each candidate bond.

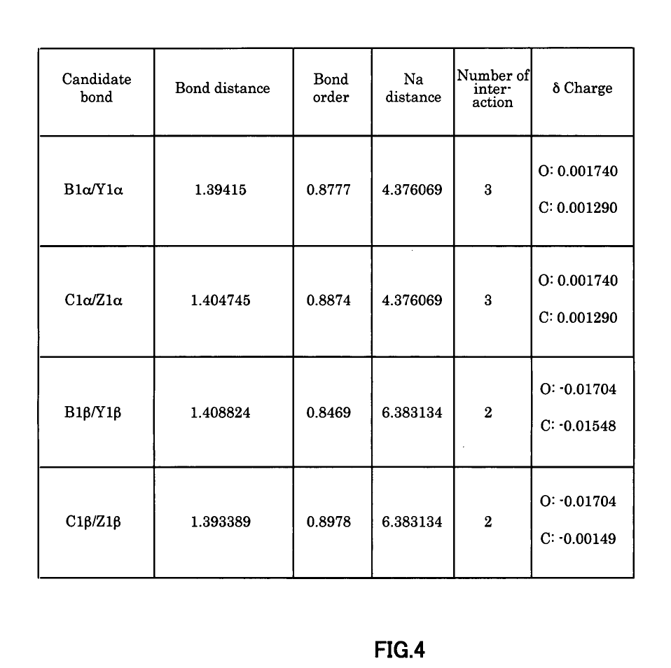

FIG. 4 is a drawing illustrating binding parameters of each candidate bond of an oligosaccharide GalNAcβ1-3(Fucα1-2)Gal (see, FIG. 2) ionized by addition of Na ion. Hereinafter, each of the binding parameter will be explained. The bond length is a distance between the oxygen atom and the carbon atom constituting the candidate bond. The bond order is the order indicating multiplicity of the covalent bond between the oxygen atom and the carbon atom constituting the candidate bond. The Na distance is a distance between the added Na ion and the oxygen atom of the candidate bond. The number of interacted atoms is a number of oxygen atoms interacted with Na ion among oxygen atoms constituting the monosaccharides bound by the candidate bond. Herein, the oxygen atoms positioned within 3 angstrom away from the Na ion are counted in the oxygen atoms interacted with the Na ion. With respect to the number of interacted atoms, explanation will be made using a contact map showing the distance between the Na ion and the oxygen atom included in the oligosaccharide.

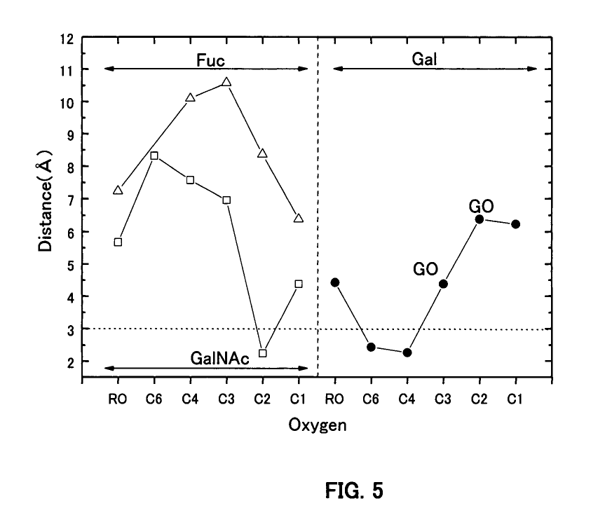

FIG. 5 is a contact map of an oligosaccharide GalNAcβ1-3(Fucα1-2)Gal (see, FIG. 2) ionized by addition of a Na ion. Abscissa of the contact map indicates oxygen atoms in the oligosaccharide, and ordinate indicates the distance between the Na ion and the oxygen atom. Data of galactose are plotted on the right hand of the contact map. Data of fucose and N-acetylgalactosamine are plotted on the left hand of the contact map. As shown in FIG. 5, the oxygen atoms positioned within 3 angstrom away from the Na ion are the oxygen atom C2 in N-acetylgalactosamine, and the oxygen atoms C4 and C6 in galactose. In the oligosaccharide shown in FIG. 2, number of interacted atoms of the candidate bond B1α/Y1α is “3” because it is the number of oxygen atoms included in N-acetylgalactosamine and galactose. With respect to the candidate bond C1α/Z1α, the number of interacted atoms is similarly “3”. Number of interacted atoms of the candidate bond B1β/Y1β and the candidate bond C1β/Z1β is “2” because it is the number of the oxygen atoms included in fucose and galactose.

Magnitude of alteration of charge is alteration of the charge accompanied by addition of Na ion to the oxygen atom and carbon atom in the candidate bond. For example, δ charge, magnitude of alteration of charge of the oxygen atoms, may be determined assuming that the charge when any Na ion is not added is referred to as “O charge (neutral)”, while the charge when Na ion is added is referred to as “O charge (Na addition)”:
charge=O charge (Na addition)−O charge (neutral) (1).

Contact map production part 30 produces the contact map shown in FIG. 5 according to the results of geometry optimization provided by the geometry optimization part 22.

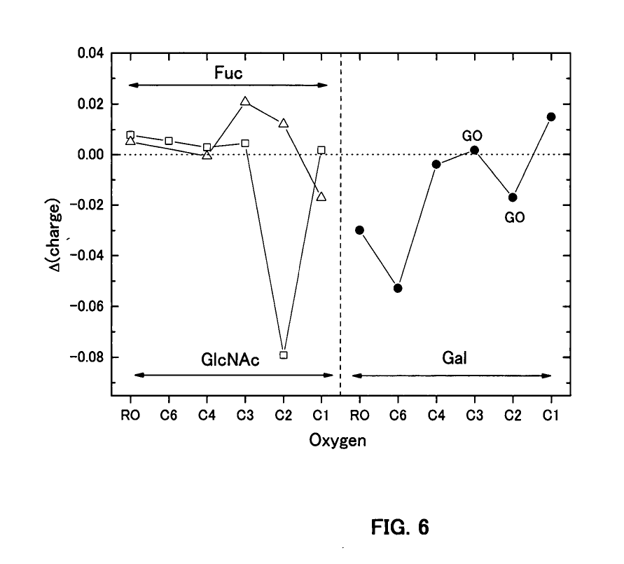

Charge map production part 32 produces a charge map suggesting the magnitude of alteration of charge for all the oxygen atoms in the oligosaccharide. FIG. 6 is a drawing illustrating the charge map. Abscissa of the charge map indicates the oxygen atom in the oligosaccharide, and ordinate indicates the magnitude of alteration of charge. Magnitude of alteration of charge of the oxygen atoms other than the oxygen atoms of the candidate bond can be also determined according to the above formula (1).

Referring back to FIG. 3, parameter conversion part 34 has a function to convert the binding parameter of each candidate bond extracted at the binding parameter extraction part 28 into a score which can be treated integrally. More particularly, the parameter conversion part 34 assigns the order of bond strengths of the multiple candidate bonds in increasing order on the basis of individual binding parameters, and the binding score which correlates to the binding parameter is determined in accordance with their order. Thus, the binding parameter can be converted into the binding score which correlates to magnitude relationship of the same kind of multiple binding parameters.

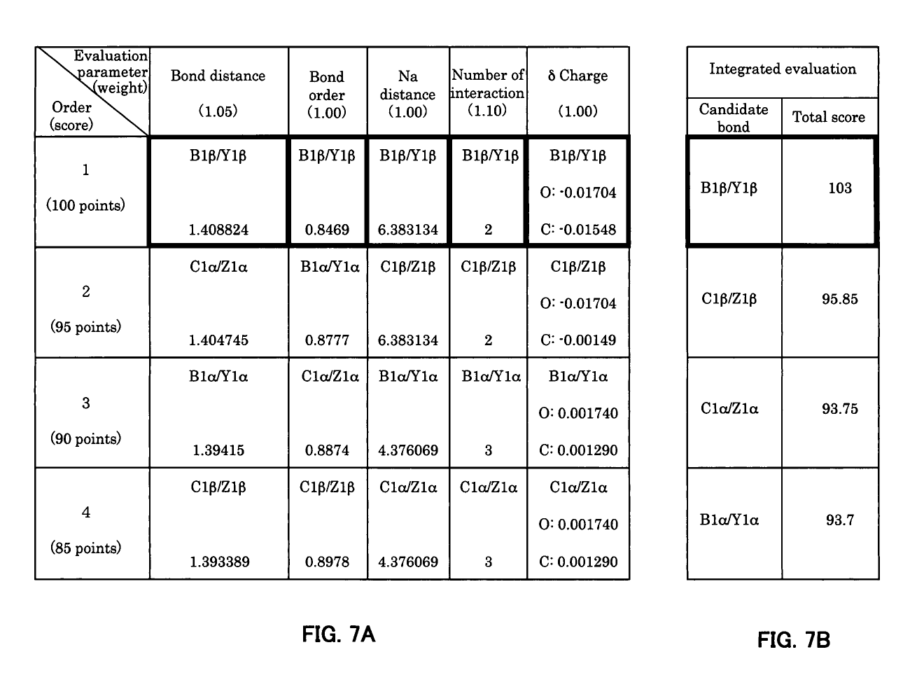

Explanation is now made taking the bond length shown in FIG. 4 as an example. In connection with the binding parameter of the bond length, greater bond length results in weaker bond strength. In FIG. 4, the candidate bond B1β/Y1β with the bond length of “1.408824” ranks first. The following great bond length is found in the candidate bond C1α/Z1α, and the candidate bonds B1α/Y1α and C1β/Z1β follow. Therefore, the parameter conversion part 34 assigns the order of each candidate bond in connection with the binding parameter of the bond length as shown in FIG. 7A. The parameter conversion part 34 gives scores of 100 points to the first rank, 95 points to the second rank, 90 points to the third rank and 85 points to the fourth rank depending on the given order. Hence, it is decided that the scores of bond length are 100 points for the candidate bond B1β/Y1β, 95 points for the candidate bond C1α/Z1α is 95 points, 90 points for the candidate bond B1α/Y1α, and 85 points for the candidate bond C1β/Z1β.

Other binding parameter is also converted into the score according to the order similarly to the bond length. In connection with the bond order, the order is given in increasing order of the bond order, and the order is given in decreasing order of the Na distance in connection with the Na distance, in increasing order of the number of interacted atoms in connection with the number of interacted atoms, and in increasing order of the magnitude of alteration of charge in connection with the magnitude of alteration of charge (see, FIG. 7A). With respect to the magnitude of alteration of charge, provided that candidate bonds have the same magnitude of alteration of charge of the oxygen atoms, the order is given according to the magnitude of alteration of charge of the carbon atoms.

In connection with the Na distance and the number of interacted atoms, the values shall be equal for two candidate bonds within the same glycosidic linkage. As shown in FIG. 4, as for the Na distance, for example, values of the candidate bond B1β/Y1β and the candidate bond C1β/Z1β are equal, and values of the candidate bond B1α/Y1α and the candidate bond C1α/Z1α are equal. In this instance, the order may be assigned to both of the candidate bond B1β/Y1β and the candidate bond C1β/Z1β as the first rank, and both the candidate bond B1α/Y1α and the candidate bond C1α/Z1α as the third rank. The candidate bond B1β/Y1β and the candidate bond C1β/Z1β are both scored as 100 points, and the candidate bond B1α/Y1α and the candidate bond C1α/Z1α are both scored as 90 points. With respect to the number of interacted atoms, the score may be decided similarly to the Na distance.

In this embodiment, scores which decrease by five points from the higher order were given, however, the score may be decided according to any method without limitation to the method of this embodiment.

Referring back to FIG. 3, total score calculating part 36 has a function to calculate total score of the candidate bond from the multiple kinds of binding scores converted in the parameter conversion part 34. The total score calculating part 36 determines integrated evaluation of each candidate bond using the weight information read from weight information storage part 38. The weight information is now explained.

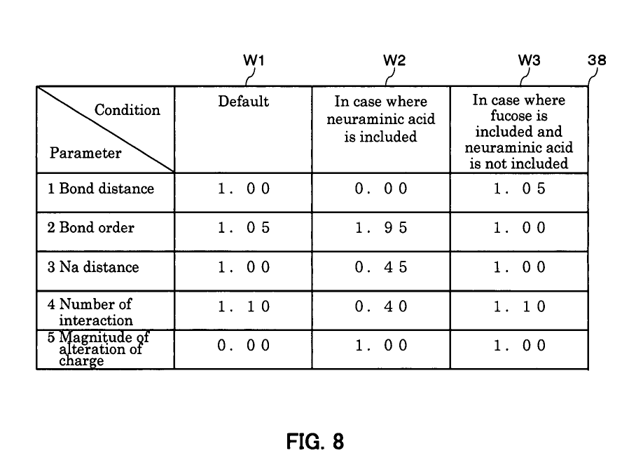

FIG. 8 is a drawing illustrating an example of the weight information stored in the weight information storage part 38. As shown in FIG. 8, the weight information representing the contribution of multiple binding scores to respective bond strengths is stored in the weight information storage part 38. For example, with reference to weight information W1, because of the bond length being “1”, the bond order being “1.05”, the Na distance being “1”, the number of interacted atoms being “1”, and the magnitude of alteration of charge being “0”, the binding score of the bond order has the weight of 1.05 times of the binding score of the bond length. The magnitude of alteration of charge being “0” suggests that the magnitude of alteration of charge is not included in the total score.

In the weight information storage part 38, three kinds of weight information are stored depending on the kind of the monosaccharide included in the oligosaccharide. The weight information W1 is default weight information. Weight information W2 is the weight information applied when neuraminic acid is included in the oligosaccharide. Weight information W3 is the weight information applied when neuraminic acid is not included but fucose is included in the oligosaccharide. The default weight information W1 may be applied to all oligosaccharides to which the weight information W2 and W3 may not be applied.

The weight information stored in the weight information storage part 38 may be decided based on the experimental results of the fragmentation patterns of known sample oligosaccharides determined by mass spectrometry. Specifically, the fragmentation pattern of a sample oligosaccharide is first determined in an experiment by mass spectrometry. Accordingly, as to which candidate bond is readily cleaved can be determined experimentally in the sample oligosaccharide. On the other hand, geometry optimization is carried out using data of the chemical formula of the sample oligosaccharide. From the calculation results, the binding parameter is extracted for respective candidate bonds within the sample oligosaccharide, and the extracted binding parameter is converted into the binding score. As in the foregoings, experimental results of the fragmentation pattern, and the binding scores of respective candidate bonds are determined for multiple oligosaccharide samples. Comparing the experimental results of multiple samples with the binding scores, contribution of respective multiple kinds of binding scores is decided such that total score of the candidate bond cleaved by the experiment becomes high.

In this embodiment, the weight information storage part 38 including three kinds of weight information is explained, however, the kind of the weight information is not limited to the three. For example, when it was proven that the fragmentation pattern of the oligosaccharide can be more appropriately analyzed using weight information that is different from the above three kinds of weight information depending on the kind of the monosaccharides, weight information which meets with the oligosaccharide may be added to the weight information storage part 38.

The total score calculating part 36 determines total score obtained by weighing the score of each binding parameter by the weight information read from the weight information storage part 38, as the integrated evaluation. Specifically, average of the scores after weight correction obtained by multiplying the score of each binding parameter by the value of the weight information is defined as total score.

Cleavage site deciding part 40 has a function to decide a candidate bond that is most cleavable based on the total score of each candidate bond calculated at the total score calculating part 36. In this embodiment, the candidate bond exhibiting the highest total score is decided as the most cleavable bond. The cleavage site deciding part 40 gives the information of thus decided candidate bond to analysis result output part 42, and allows the information to output from the analysis result output part 42. As a result of the oligosaccharide being cleaved at the decided candidate bond, the cleavage site deciding part 40 calculates the molecular weight of the fragmented oligosaccharide, and allows output from the analysis result output part 42.

The analysis result output part 42 has a function to output the analysis results and the like of the fragmentation pattern of the oligosaccharide.

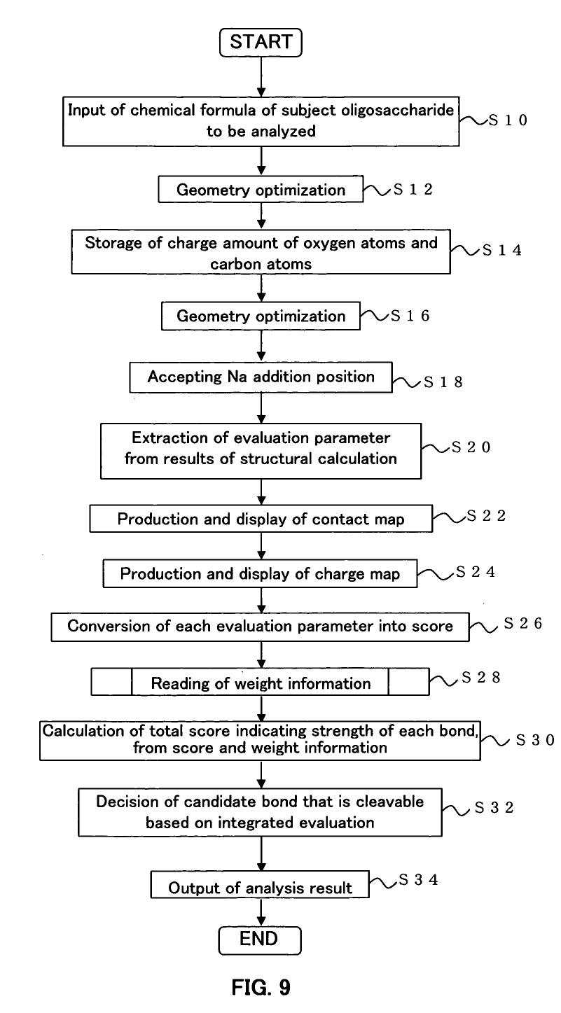

FIG. 9 shows a flow chart illustrating the operation of the oligosaccharides fragmentation pattern analysis system 10. With regard to the operations of the oligosaccharides fragmentation pattern analysis system 10, explanation will be made with reference to FIG. 9. Example of analysis of the fragmentation pattern of the oligosaccharide shown in FIG. 2 is now explained.

First, the input part 16 of the oligosaccharides fragmentation pattern analysis system 10 accepts the data input of the chemical formula of the subject oligosaccharide to be analyzed, and the accepted data are given to the geometry optimization part 22 (S10). The geometry optimization part 22 of the oligosaccharides fragmentation pattern analysis system 10 carries out geometry optimization of the oligosaccharide based on the accepted data (S12). The oligosaccharides fragmentation pattern analysis system 10 inputs the results of the geometry optimization to the Na addition candidate position calculating part 24 and the binding parameter extraction part 28. The binding parameter extraction part 28 extracts and stores charge amount of the oxygen atoms and the carbon atoms within the oligosaccharide from the results of the geometry optimization (S14). In this step, the charge amount is stored in the neutral state prior to addition of the Na ion to the oligosaccharide.

Next, the Na addition candidate position calculating part 24 determines the addition candidate position, to which the Na ion can be added, based on the calculation results of geometry optimization, and gives data of the determined addition candidate position to the geometry optimization part 22. When the geometry optimization part 22 accepts the data of the Na addition candidate position from the Na addition candidate position calculating part 24, geometry optimization of the oligosaccharide when Na ion was added to addition candidate positions, respectively, is carried out (S16). The geometry optimization part 22 gives the results of the geometry optimization for respective oligosaccharides to the Na addition candidate position calculating part 24. The Na addition candidate position calculating part 24 decides the order of facility in adding the Na ion to respective multiple addition candidate positions based on the results of geometry optimization. Specifically, heat of formation in the neutral state in which Na ion is not added and the state in which Na ion is added to respective addition candidate positions is determined, and the order is decided depending on the difference.

The Na addition candidate position calculating part 24 gives data of the multiple Na addition candidate positions, and data indicating the order of facility in adding Na ion to respective candidate positions, to the selection accepting part 26. The selection accepting part 26 displays the addition candidate positions of Na, and the order of facility in adding Na ion to respective candidate positions, based on the date given from the Na addition candidate position calculating part 24. The selection accepting part 26 prompts user to select addition position of the Na ion from the candidate positions, and accepts the selection of the Na addition position from the multiple addition candidate positions (S18). Although this embodiment is constituted to support selection of the Na addition position through displaying facility in adding the Na ion to respective addition candidate positions, construction in which the order of facility in adding Na ion is not displayed is also permitted.

When the addition position of Na ion is selected, the binding parameter extraction part 28 receives the results of geometry optimization of the oligosaccharide to which the Na ion is added at the selected position, from the geometry optimization part 22. The binding parameter extraction part 28 extracts five kinds of binding parameters shown in FIG. 4 from the input calculation results of the geometry optimization (S20). In this step, the binding parameter extraction part 28 determines magnitude of alteration of charge using the charge of the oxygen atoms and the carbon atoms in the neutral state which had been stored in the step S14.

Subsequently, the contact map production part 30 produces a contact map based on the calculation results of the geometry optimization (see, FIG. 5), and displays in the analysis result output part 42 (S22). The charge map production part 32 produces a charge map based on the calculation results of the geometry optimization (see, FIG. 6), and displays in the analysis result output part 42 (S24). In addition, production of the contact map and production of the charge map may be conducted prior to the extraction of the binding parameter.

Next, the parameter conversion part 34 converts the multiple kinds of binding parameters extracted in the binding parameter extraction part 28, into the binding scores which correlate thereto, respectively, (S26). Conversion from the binding parameter into the binding score by the parameter conversion part 34 may be performed so that the binding score correlates to the order of the same kinds of multiple binding parameters, as described above. The total score calculating part 36 reads weight information applied to calculation of the total score from the weight information storage part 38, depending on the kind of the monosaccharide included in the subject oligosaccharide to be analyzed (S28).

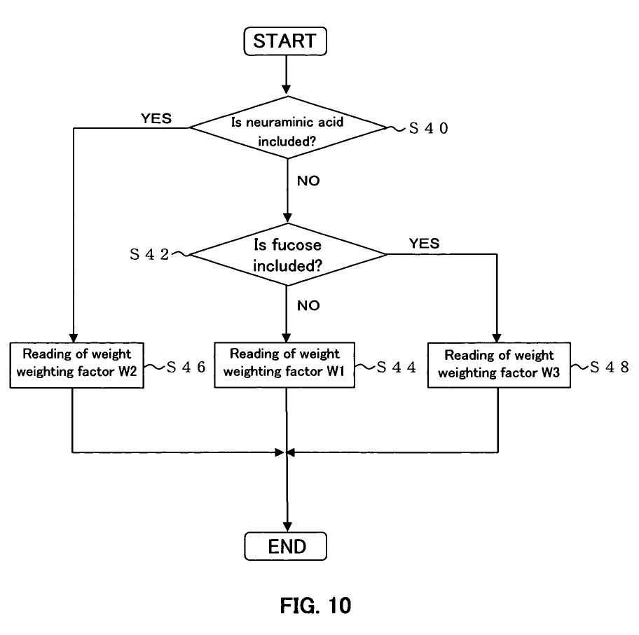

FIG. 10 shows a flow chart illustrating operations of deciding the weight information read from the weight information storage part 38 by the total score calculating part 36. The total score calculating part 36 judges whether or not neuraminic acid is included in the subject oligosaccharide to be analyzed (S40). Kind of the monosaccharide included in the subject oligosaccharide to be analyzed can be determined from the chemical formula of the oligosaccharide which had been input first. The total score calculating part 36 reads the weight information W2 of the weight information storage part 38 shown in FIG. 8, when the subject oligosaccharide to be analyzed includes neuraminic acid (S46), while it judges whether or not fucose is included in the oligosaccharide when neuraminic acid is not included (S42). The total score calculating part 36 reads the weight information W3 of the weight information storage part 38 shown in FIG. 8, when fucose is included in the subject oligosaccharide to be analyzed (S48), while default weight information W1 is read when fucose is not included in the oligosaccharide (S44). In the example of this embodiment, neuraminic acid is not included in the subject oligosaccharide to be analyzed (see, FIG. 2), therefore, judgment of “NO” is made upon judgment in the step S40, and then proceeds to judgment whether or not fucose is included in the oligosaccharide (S42). In the example of this embodiment, fucose is included in the subject oligosaccharide to be analyzed, therefore, judgment of “YES” is made upon judgment in the step S42, and then proceeds to the step S48 for reading the weight information W3.

The total score calculating part 36 weights each binding parameter using the read weight information, and derives integrated evaluation of the bond strength of each candidate bond (S30). Total score St is determined according to:
St=Σ((score of binding parameter)×(weight of binding parameter))/5 (2).

FIG. 7B is a drawing illustrating integrated evaluation of each candidate bond determined. Calculation of total score is now explained with reference to the candidate bond B1β/Y1β as an example. As shown in FIG. 7A, the score of each binding parameter of the candidate bond B1β/Y1β is 100 points. Total score of the candidate bond B1β/Y1β is calculated to be:
St=((100×1.05)+(100×1)+(100×1)+(100×1.1)+(100×1))/5=103
through applying the score of each binding parameter to the formula (2).

Next, the cleavage site deciding part 40 decides the candidate bond that is the most cleavable, based on the integrated evaluation of each candidate bond (S32). Referring to FIG. 7B, the candidate bond B1β/Y1β exhibits the highest score. The cleavage site deciding part 40 decides that the candidate bond B1β/Y1β is the most cleavable candidate bond. The cleavage site deciding part 40 determines the molecular weight of the fragmented oligosaccharide produced by cleavage of the oligosaccharide at the decided candidate bond.

Subsequently, the analysis result output part 42 of the oligosaccharides fragmentation pattern analysis system 10 displays the order of the binding parameter of each candidate bond extracted at the binding parameter extraction part 28 (see, FIG. 7A), total score of each candidate bond calculated at the total score calculating part 36 (see, FIG. 7B), and the molecular weight of the oligosaccharide following cleavage determined at the cleavage site deciding part 40, in the analysis result output part 42 (S34).

Next, the fragmentation pattern determined by the oligosaccharides fragmentation pattern analysis system 10 of this embodiment is compared with the fragmentation pattern examined by mass spectrometry.

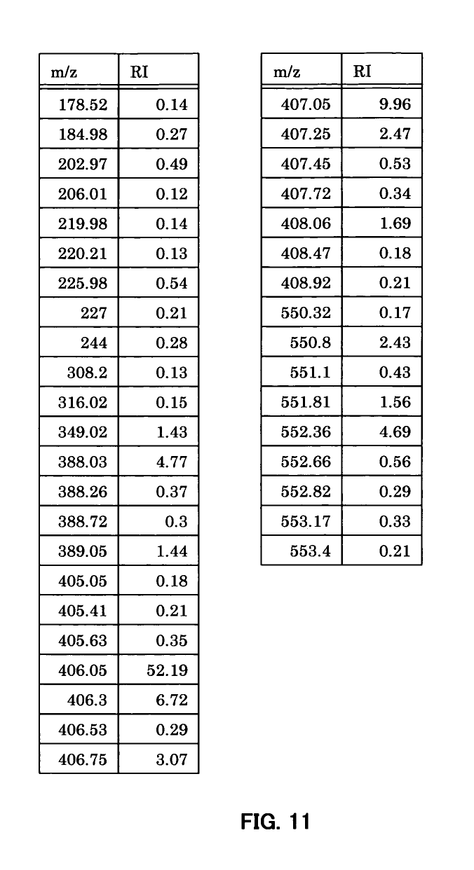

FIG. 11 shows results of examination of the fragmentation pattern of the oligosaccharide GalNAcβ1-3(Fucα1-2)Gal shown in FIG. 2 by mass spectrometry. From the results shown in FIG. 11, the highest RI (Relative Intensity) was exhibited at 406 Da. This is consistent with the weight of the oligosaccharide fragmented at the candidate bond B1β/Y1β determined by the oligosaccharides fragmentation pattern analysis system 10.

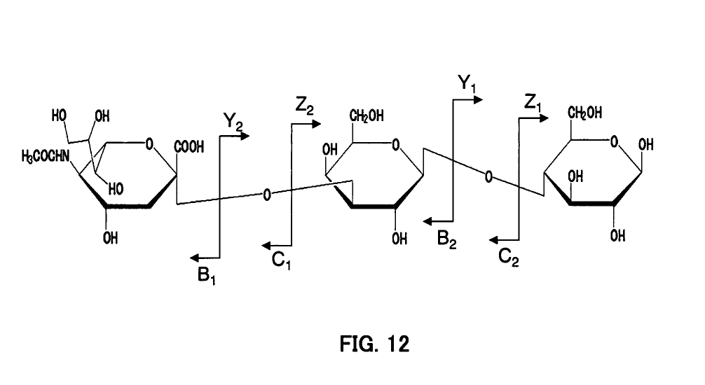

Next, an example of analysis of the oligosaccharide shown in FIG. 12 represented by the chemical formula of Neu5Acα2-3Galβ1-4Gal will be explained. The oligosaccharide shown in FIG. 12 includes three monosaccharides, i.e., N-acetylneuraminic acid and two molecules of galactose. In the oligosaccharide shown in FIG. 12, candidate bonds B1/Y2, C1/Z2, B2/Y1 and C2/Z1 are included at four sites.

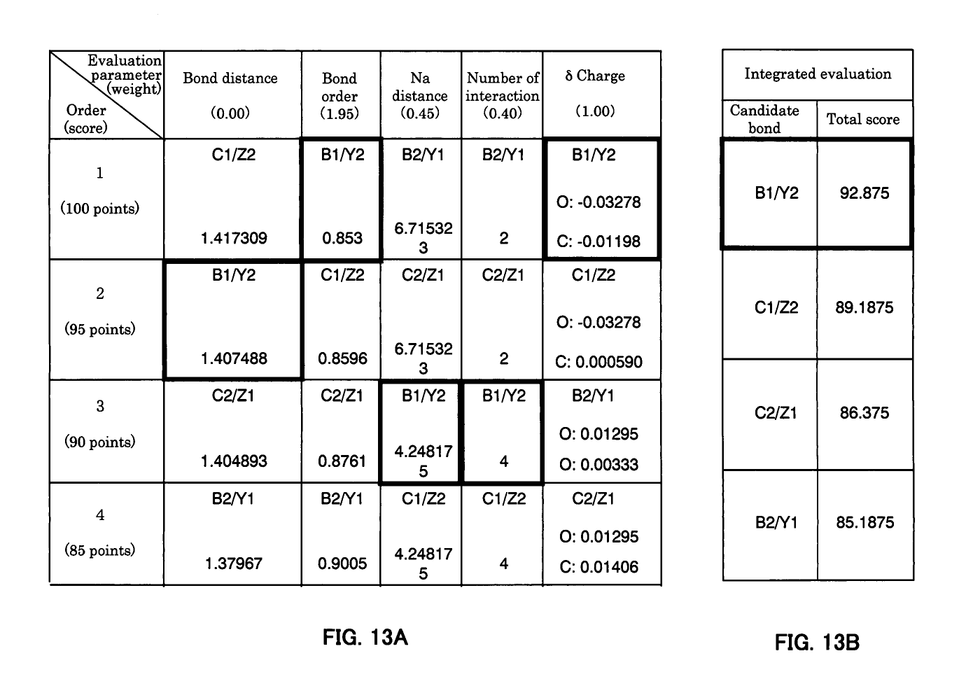

FIG. 13A is a drawing illustrating the score of the binding parameter of each candidate bond of the oligosaccharide shown in FIG. 12. Because neuraminic acid is included in the oligosaccharide shown in FIG. 12, the weight information W2 is read from the weight information storage part 38. Results of determination of the total score of each candidate bond using the weight information W2 are shown in FIG. 13B. According to the total score shown in FIG. 13B, it is proven that the candidate bond B1/Y2 is the most cleavable candidate bond.

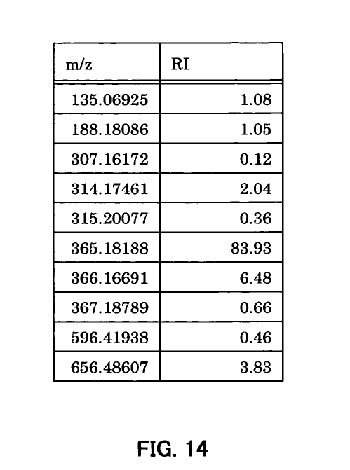

FIG. 14 shows results of examination of the fragmentation pattern of the oligosaccharide shown in FIG. 12 by mass spectrometry. Results shown in FIG. 14 suggest that the highest RI (Relative Intensity) was exhibited at 365 Da. This result is consistent with the weight of the oligosaccharide fragmented at the candidate bond B1/Y2 determined by the oligosaccharides fragmentation pattern analysis system 10.

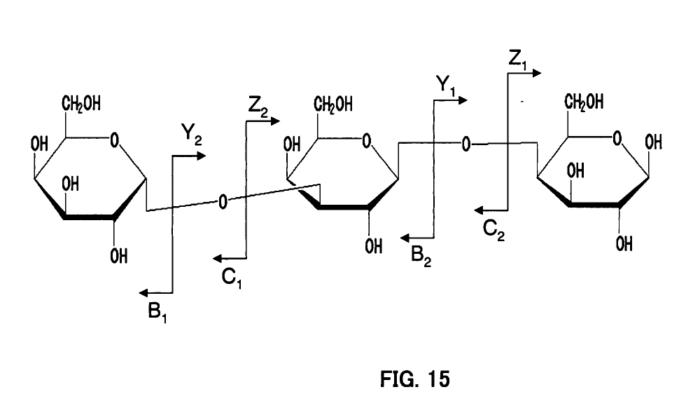

Next, an example of analysis of the oligosaccharide shown in FIG. 15 represented by the chemical formula of Galα1-3Galβ1-Gal will be explained. The oligosaccharide shown in FIG. 15 is constituted from three molecules of galactose bound with two glycosidic linkages. In the oligosaccharide shown in FIG. 15, candidate bonds B1/Y2, C1/Z2, B2/Y1 and C2/Z1 are included at four sites.

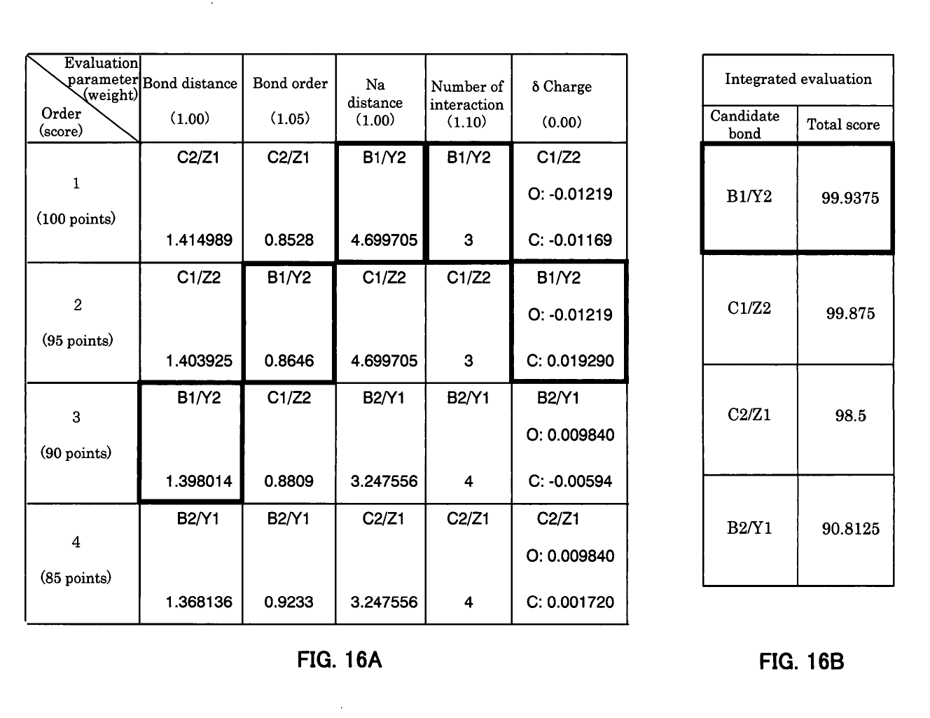

FIG. 16A is a drawing illustrating the score of the binding parameter of each candidate bond of the oligosaccharide shown in FIG. 15. Because neither neuraminic acid nor fucose is included in the oligosaccharide shown in FIG. 15, default weight information W1 is read from the weight information storage part 38. Results of determination of the total score of each candidate bond using the weight information W1 are shown in FIG. 16B. According to the total score shown in FIG. 16B, it is proven that the candidate bond B1/Y2 is the most cleavable candidate bond.

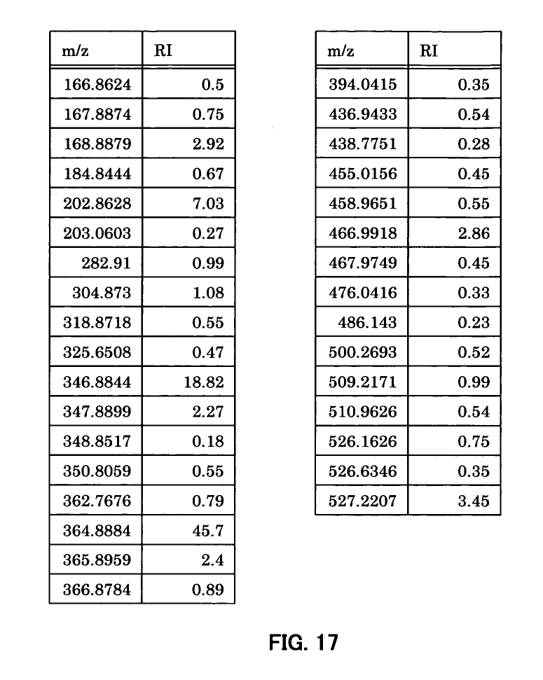

FIG. 17 shows results of examination of the fragmentation pattern of the oligosaccharide shown in FIG. 15 by mass spectrometry. Results shown in FIG. 17 suggest that the highest RI (Relative Intensity) was exhibited at 365 Da. This result is consistent with the weight of the oligosaccharide fragmented at the candidate bond B1/Y2 determined by the oligosaccharides fragmentation pattern analysis system 10.

As described hereinabove, the fragmentation pattern determined by the oligosaccharides fragmentation pattern analysis system 10 of the embodiment is well consistent with the result obtained by examination with mass spectrometry. Accordingly, usefulness of the oligosaccharides fragmentation pattern analysis system 10 of this embodiment was ascertained.

The oligosaccharides fragmentation pattern analysis system 10 of this embodiment can analyze the fragmentation pattern of monosaccharides by calculation through extracting the binding parameter of each candidate bond from the calculation results of geometry optimization of the oligosaccharide to which a cation is added, and determining the binding score representing the information of the fragmentation pattern based on the extracted binding parameter.

The oligosaccharides fragmentation pattern analysis system 10 of this embodiment can determine total score with favorable accuracy by converting the binding parameter into a binding score, which can be treated integrally, in the parameter conversion part 34.

The oligosaccharides fragmentation pattern analysis system 10 of this embodiment can determine total score appropriately from multiple kinds of binding parameters through determining total score using the weight information representing contribution to the bond strength.

By analyzing fragmentation pattern with the oligosaccharides fragmentation pattern analysis system 10 of this embodiment, the fragmentation pattern can be determined far rapidly than experimental determination of the fragmentation pattern by mass spectrometry. Accordingly, it serves in analyses of oligosaccharides having structural diversity. Because fragmentation pattern of oligosaccharides can be rapidly calculated by the oligosaccharides fragmentation pattern analysis system 10 of this embodiment, fragmentation patterns for lot of oligosaccharides can be accumulated in a short time period. Thus, a database having fragmentation patterns accumulated for enormous number of oligosaccharides can be constructed. Utilization of this database enables identification of unknown oligosaccharides. More specifically, unknown oligosaccharides can be identified by determining the fragmentation pattern of unknown oligosaccharide by mass spectrometry, and searching for an oligosaccharide that agrees with the determined fragmentation pattern from the database.

As in the foregoings, the oligosaccharides fragmentation pattern analysis system 10 of the invention was explained in detail with reference to embodiments, however, the invention is not anyhow limited to the above-described embodiments.

In the embodiments described hereinabove, integrated evaluation of the bond strength of the candidate bond was determined using binding parameters such as bond length, bond order, Na distance, number of interacted atoms and magnitude of alteration of charge, however, resonant term suggesting the electronic state of the oxygen atoms and the carbon atoms of the candidate bond may be also used as the binding parameter.

In the embodiment described above, addition position of the Na ion was decided through acceptance of selection from the user by the selection accepting part 26, however, a construction in which the addition position of the Na ion is automatically decided may be also adopted. Position to which Na ion is most liable to be added may be decided as the Na addition position, judging from the order of facility in adding the Na ion to the addition candidate position determined at the geometry optimization part 22.

In the embodiment described above, oligosaccharides fragmentation pattern analysis system was constructed from multiple computers 12 and 14, however, the oligosaccharides fragmentation pattern analysis system may be also constructed from one computer.

As explained above, the invention has an excellent effect that fragmentation pattern can be analyzed by calculation through determining total score representing the information of the fragmentation pattern based on the binding parameter of each candidate bond, which is useful as an oligosaccharides fragmentation pattern analysis system and the like permitting analysis of fragmentation patterns of ionized oligosaccharides.

Persons of ordinary skill in the art will realize that many modifications and variations of the above embodiments may be made without departing from the novel and advantageous features of the present invention. Accordingly, all such modifications and variations are intended to be included within the scope of the appended claims. The specification and examples are only exemplary. The following claims define the true scope and spirit of the invention.

What is claimed is:

1. An oligosaccharides fragmentation pattern analysis system for analyzing a fragmentation pattern of an oligosaccharide ionized to obtain mass spectra for oligosaccharides, by calculation based on the molecular structure, the system comprising:
a geometry optimization part for calculating the optimized structure of the oligosaccharide ionized by addition of a cation;
a binding parameter extraction part for extracting respective multiple kinds of binding parameters which relate to bond strengths for multiple candidate bonds, which are to be the candidate of cleavage site within the oligosaccharide, on the basis of results of calculation by means of the geometry optimization part;
a parameter conversion part for converting respective multiple kinds of binding parameters extracted at the binding parameter extraction part into binding scores such that the binding score correlates to magnitude relationship of the same kind of binding parameter in the multiple candidate bonds;
a weight information storage part for storing weight information which represents contribution to respective bond strengths, of multiple kinds of the binding scores correlating to the multiple kinds of binding parameters; and
a total score calculating part for reading the weight information from the weight information storage part and for determining total score of the multiple kinds of binding scores in each candidate bond as the information representing the fragmentation pattern of the oligosaccharide such that the multiple kinds of binding parameters are weighed according to the read weight information.

2. The oligosaccharides fragmentation pattern analysis system according to claim 1 which comprises a cleavage site deciding part for deciding a candidate bond that is most cleavable, based on the total score calculated at the total score calculating part.

3. The oligosaccharides fragmentation pattern analysis system according to claim 1 wherein the binding parameter extraction part extracts, as the binding parameter, multiple parameters among bond length and bond order of the candidate bond, distance between the candidate bond and the cation, number of interacted oxygen atoms with the metal cation among oxygen atoms included in the monosaccharide linked by the candidate bond, magnitude of alteration of charge of oxygen atoms and carbon atoms of the candidate bond, accompanied by addition of the cation, and resonant term indicating the electronic state of the oxygen atoms and carbon atoms of the candidate bond.

4. The oligosaccharides fragmentation pattern analysis system according to claim 3 wherein the binding parameter extraction part changes the parameter extracted as the binding parameter depending on kinds of the monosaccharides included in the subject oligosaccharide to be analyzed.

5. The analytical system of the oligosaccharides fragmentation pattern according to claim 1 wherein the binding parameter extraction part extracts, as the binding parameter, the bond length and bond order of the candidate bond, the distance between the candidate bond and the cation, and the number of interacted oxygen atoms with metal cation among oxygen atoms included in the monosaccharide linked by the candidate bond.

6. The oligosaccharides fragmentation pattern analysis system according to claim 5 wherein the binding parameter extraction part extracts, as the binding parameter, the bond order of the candidate bond, the distance between the candidate bond and the cation, the number of interacted oxygen atoms with metal cation among oxygen atoms included in the monosaccharide linked by the candidate bond, and the magnitude of alteration of charge of oxygen atoms and carbon atoms of the candidate bond, accompanied by addition of the cation, when neuraminic acid is included in the subject oligosaccharide to be analyzed.

7. The oligosaccharides fragmentation pattern analysis system according to claim 6 wherein the binding parameter extraction part extracts, as the binding parameter, the bond length and bond order of the candidate bond, the distance between the candidate bond and the cation, the number of interacted oxygen atoms with metal cation among oxygen included in the monosaccharide linked by the candidate bond, and the magnitude of alteration of charge of oxygen atoms and carbon atoms of the candidate bond, accompanied by addition of the cation, when the subject oligosaccharide to be analyzed includes fucose and does not include neuraminic acid.

8. The oligosaccharides fragmentation pattern analysis system according to claim 1 wherein the weight information storage part stores multiple weight information in association with kind of the monosaccharide included in the subject oligosaccharide to be analyzed; and
the total score calculating part reads the weight information, which correlates to the kind of the monosaccharide included in the subject oligosaccharide to be analyzed, from the weight information storage part, and calculates the total score using thus read weight information.

9. The oligosaccharides fragmentation pattern analysis system according to claim 8 wherein, for the weight information applied in cases where neuraminic acid is included in the subject oligosaccharide to be analyzed among the multiple weight information stored in the weight information storage part, contribution to the bond strength of the binding score correlating to the binding parameter of the bond order of the candidate bond is set to be greater, while contribution to the bond strength of the binding score correlating to the binding parameter of the distance between the candidate bond and the cation and the cation and of the number of interacted oxygen atoms with metal cation among oxygen atoms included in the monosaccharide linked by the candidate bond is set to be smaller, in comparison with cases where neuraminic acid is not included in the subject.

10. The oligosaccharides fragmentation pattern analysis system according to claim 1 wherein the parameter conversion part assigns the order of all the candidate bonds within the oligosaccharide based on the same type of the binding parameter, and converts into the binding score of the candidate bond according to the order.

11. The oligosaccharides fragmentation pattern analysis system according to claim 1 which comprises:
a chemical formula input part which accepts input of the chemical formula of the subject oligosaccharide to be analyzed;
an addition candidate position calculating part for determining, as an addition candidate position, a position to which a cation can be added on the basis of the optimized structure of the oligosaccharide; and
a selection accepting part for displaying the addition candidate position determined by the addition candidate position calculating part, and for accepting selection of the position to which the cation is added from the displayed addition candidate positions,
wherein the geometry optimization part calculates the optimized structure of the oligosaccharide having the cation added to the position accepted by the selection accepting part.

12. The oligosaccharides fragmentation pattern analysis system according to claim 1 which comprises:
a chemical formula input part for accepting input of the chemical formula of the subject oligosaccharide to be analyzed; and
an addition candidate position calculating part for determining the position to which the cation can be added as the addition candidate position on the basis of the optimized structure of the oligosaccharide,
wherein the optimized structure of the oligosaccharide when the cation is added to respective addition candidate positions is calculated by the geometry optimization part to determine stability of each oligosaccharide from the results of the calculation, and
a cation addition position deciding part for deciding the position to which the cation is added, on the basis of the stability of each oligosaccharide is provided.

13. An oligosaccharides fragmentation pattern analysis method for analyzing a fragmentation pattern of an oligosaccharide ionized to obtain mass spectra for oligosaccharides, by calculation based on the molecular structure, the method comprising steps of:
geometry optimization for calculating the optimized structure of the oligosaccharide ionized by addition of a cation;
binding parameter extraction for extracting multiple kinds of binding parameters which relate to bond strengths for multiple candidate bonds, respectively, which are to be the candidate of cleavage site within the oligosaccharide, on the basis of results of calculation in the geometry optimization step;
parameter conversion for converting respective multiple kinds of binding parameters extracted at the binding parameter extraction step into binding scores such that the binding score correlates to magnitude relationship of the same kind of binding parameter in the multiple candidate bonds;
weight information reading for reading the weight information which represents contribution to respective bond strengths of multiple kinds of the binding scores correlating to the multiple kinds of binding parameters, from the weight information storing part; and
total score calculation for determining total score of the multiple kinds of binding scores in each candidate bond as the information representing the fragmentation pattern of the oligosaccharide such that the multiple kinds of binding parameters are weighed according to the weight information read in the weight information reading step.

14. A program for analyzing a fragmentation pattern of an oligosaccharide ionized to obtain mass spectra for oligosaccharides, by calculation based on the molecular structure, the program allowing a computer to execute steps of:
geometry optimization for calculating the optimized structure of the oligosaccharide ionized by addition of a cation;
binding parameter extraction for extracting multiple kinds of binding parameters which relate to bond strengths for multiple candidate bonds, respectively, which are to be the candidate of cleavage site within the oligosaccharide, on the basis of results of calculation in the geometry optimization step;
parameter conversion for converting respective multiple kinds of binding parameters extracted at the binding parameter extraction step into binding scores such that the binding score correlates to magnitude relationship of the same kind of binding parameter in the multiple candidate bonds;
weight information reading for reading the weight information which represents contribution to respective bond strengths of multiple kinds of the binding scores correlating to the multiple kinds of binding parameters, from the weight information storing part; and
total score calculation for determining total score of the multiple kinds of binding scores in each candidate bond as the information representing the fragmentation pattern of the oligosaccharide such that the multiple kinds of binding parameters are weighed according to the weight information read in the weight information reading step.
